(19) United States
(12) Patent Application Publication
(10) Pub. No.: US 2017/0337882 A1
(43) Pub. Date: Nov. 23, 2017

(54) IMAGE DISPLAY DEVICE AND IMAGE DISPLAY METHOD

(71) Applicant: NEC Display Solutions, Ltd., Tokyo (JP)

(72) Inventor: Shinya NIIOKA, Tokyo (JP)

(21) Appl. No.: 15/535,855

(22) PCT Filed: Dec. 19, 2014
(86) PCT No.: PCT/JP2014/083683

§ 371 Date: Jun. 14, 2017

(51) Int. Cl. G09G 3/34; G09G 3/36

(52) U.S. Cl. CPC G09G 3/3406; G09G 3/3677; G09G 2320/08; G09G 2320/043; G09G 2320/0233; G09G 2360/141; G09G 2320/064

(57) ABSTRACT

The energy of light irradiated by a backlight causes stress on TFTs for controlling transmissivity for each pixel on a display panel so as to degrade TFTs. The present invention addresses the problem concerning disturbance in transmissivity control based on image information and incapacity of displaying images with desired luminance. The present invention includes a backlight, a transmission-type display panel disposed on the front face of the backlight, a cumulative quantity calculation part configured to calculate a cumulative quantity representing either the cumulated electric energy cumulating power supplied to the backlight or the cumulated light quantity of the backlight, and a display panel controller configured to change a driving condition for the display panel depending on the cumulative quantity.

### TECHNICAL FIELD

The present invention relates to an image display device such as a liquid crystal monitor and an image display method for displaying images on a liquid crystal monitor.

### BACKGROUND ART

Recently, image display devices using display panels such as liquid crystal monitors, which are designed to display images while controlling gradation in the quantity of transmitted light emitted from backlights by controlling their transmissivity, have been frequently used (see Patent Literature 1).

### CITATION LIST

### Patent Literature

Patent Literature 1: Japanese Patent No. 5208261

### SUMMARY OF INVENTION

### Technical Problem

It is necessary to solve a problem with a display device of Patent Literature 1 designed to irradiate light emitted from a backlight to TFTs (Thin Film Transistors) for controlling the transmissivity of a display panel. The energy of the irradiated light causes stress on TFTs for controlling a transmissivity for each pixel in a display panel. The stress causes degradation such as decrease of current values flowing through TFTs in an ON state and fluctuations in thresholds of TFTs (e.g. increase of thresholds) in an ON/OFF operation. The degradation of TFTs may occur similarly in any types of materials for TFTs such as amorphous silicon, polysilicon, oxide semiconductor, and organic semiconductor.

It is necessary to solve a problem about an inability of displaying images with desired luminance since the degradation of TFTs makes it impossible to control transmissivity with respect to image information when controlling the transmissivity of a display panel for displaying images.

### Solution to Problem

The present invention is directed to an image display device including a backlight, a display panel of a transmission type disposed on the front face of the backlight, a cumulative quantity calculation part configured to calculate a cumulative quantity representing either the cumulated electric energy that sums up power supplied to the backlight or the cumulated light quantity of the backlight, and a display panel controller configured to change a driving condition for the display panel depending on the cumulative quantity.

The present invention is directed to an image display method adapted to an image display device including a backlight, a display panel of a transmission type disposed on the front face of the backlight, a cumulative quantity calculation part configured to calculate a cumulative quantity representing either the cumulated electric energy cumulating power supplied to the backlight or the cumulated light quantity of the backlight, and a display panel controller. The image display method includes a process that the cumulative quantity calculation part calculates the cumulative quantity representing either the cumulated electric energy cumulating power supplied to the backlight or the cumulated light quantity of the backlight, and a process that the display panel controller changes a driving condition for the display panel based on the cumulative quantity.

### Advantageous Effects of Invention

According to the present invention that is designed to change driving conditions for TFTs depending on the degree of degradation of TFTs when controlling the transmissivity of a display panel for displaying images, it is possible to display images with desired luminance by controlling the transmissivity based on image information (image data).

### BRIEF DESCRIPTION OF DRAWINGS

FIG. 1 shows an example of a configuration of an image display device 1 according to the first embodiment of the present invention.

FIG. 2 shows an example of a configuration of a display panel control table stored on a storage unit 15.

FIG. 3 is a graph showing the correlation between cumulated electric energy and gate-on voltage VGon.

FIG. 4 is another graph showing the correlation between cumulated electric energy and gate-on voltage VGon.

FIG. 5 is a flowchart showing an example of a procedure for driving a display panel 11 with the image display device 1.

FIG. 6 shows an example of another configuration of a display panel control table stored on the storage unit 15.

FIG. 7 shows an example of a configuration of an image display device 1A according to the second embodiment of the present invention.

FIG. 8 shows an example of a configuration of a display panel control table stored on a storage unit 15A.

FIG. 9 is a flowchart showing an example of a procedure for driving the display panel 11 with the image display device 1A.

FIG. 10 shows an example of another configuration of a display panel control table stored on the storage unit 15A.

FIG. 11 shows an example of a configuration of an image display device 2 according to the third embodiment of the present invention.

FIG. 12 is a flowchart showing an example of a procedure for driving a display panel 21 with the image display device 2.

FIG. 13 shows an example of a configuration of an image display device 2A according to the fourth embodiment of the present invention.

FIG. 14 is a flowchart showing an example of a procedure for driving a display panel 21 with the image display device 2A.

FIG. 15 is a diagram used to explain the concept of the present invention.

### DESCRIPTION OF EMBODIMENTS

### First Embodiment

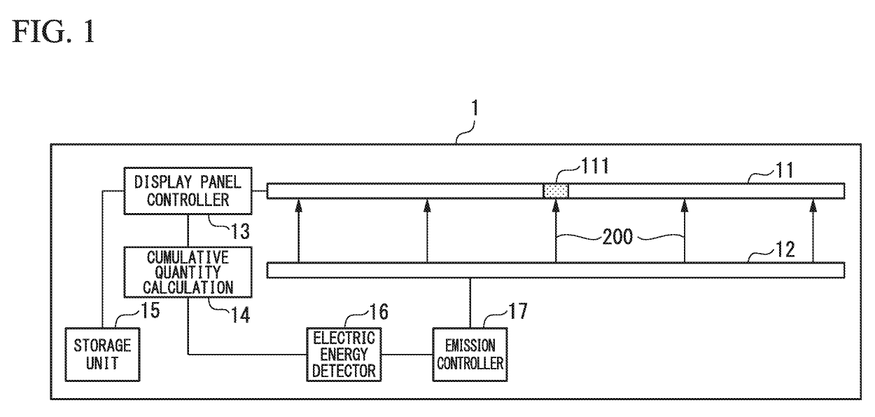

Hereinafter, an image display device according to the first embodiment of the present invention will be described with reference to the drawings. FIG. 1 shows an example of the configuration of an image display device 1 according to the first embodiment of the present invention.

As shown in FIG. 1, the image display device 1 includes a display panel 11, a backlight 12, a display panel controller 13, a cumulative quantity calculation part 14, a storage unit 15, an electric energy detector 16, and an emission controller 17.

For example, the display panel 11 is a liquid crystal panel having TFTs 111 for controlling a transmissivity for each of liquid-crystal pixels. The TFT 111 is provided for each pixel and used to carry out charging for storing charges in capacities of liquid-crystal pixels or discharging of charges. The TFT 111 is a field-effect transistor. It is possible to control transmissivities of pixels in the display panel 11 depending on the amount of charges stored in pixel capacities.

The backlight 12 is attached to a rear face disposed opposite to a display face of the display panel 11. For example, the backlight 12 is made of lighting elements such as LEDs so as to irradiate light 200 to the rear face of the display panel 11 with a desired value of luminance.

The emission controller 17 supplies power to the backlight 12 for its light emission so as to set the luminance of light emitted by the backlight 12 to a desired value.

The electric energy detector 16 calculates electric energy, which the emission controller 17 supplies to the backlight 12, based on a voltage value and a current value output from the emission controller 17 for each of predetermined sampling periods, thus supplying the calculated value of electric energy to the cumulative quantity calculation part 14. That is, power αβ (W) is calculated by multiplying a current value α (A) and a voltage value β (V), and therefore electric energy (Wh) for each sampling period is calculated by multiplying the power by a sampling period of time (h).

The cumulative quantity calculation part 14 cumulates (or totals) electric energy whose value is supplied by the electric energy detector 16 for each of predetermined sampling periods so as to write and store the cumulative result, representing cumulated electric energy, on an internal storage unit.

The display panel controller 13 reads a cumulative value of electric energy from the storage unit of the cumulative quantity calculation part 14 for each evaluation period so as to control the transmissivity for each of pixels of the display panel 11 based on the cumulative value of electric energy.

In the present embodiment as described above, the cumulative quantity calculation part 14 calculates a cumulative value of electric energy. The cumulative value of electric energy sums up the amount of power that the emission controller 17 supplies to the backlight 12 for its light emission; hence, it is equivalent to the cumulative value of light quantity representing the quantity of light actually emitted. That is, electric energy is changed stepwise and supplied to the backlight 12 while light quantity for each step is measured as light quantity, and therefore it is possible to determine the correlation between electric energy and light quantity. Thus, it is possible to easily calculate electric energy depending on light quantity according to the correlation.

A display panel control table representing the correlation between cumulative values of electric energy and driving conditions of the display panel 11 having TFTs 111 at cumulative values of electric energy (including gate driving (or transistor driving) conditions) have been written and stored on the storage unit 15 in advance. The cumulated quantity of emission represents the cumulated quantity of light irradiated to the TFTs 111 of the display panel 11; hence, it may correspond to stress applied to the TFTs 111.

For this reason, the characteristics of TFTs 111 under earliest degradation due to process dispersions among the TFTs 111 of the display panel 11 are sampled by way of acceleration experiments; hence, the display panel control table is produced in correspondence with TFTs 111 having worst characteristics.

That is, the degree of degradation may change with respect to each TFT 111, and therefore the transmissivity for each pixel controlled by one TFT 111 under early degradation differs from the transmissivity for each pixel controlled by another TFT 111 under slow degradation with respect to image data representing the same gradient. For this reason, the display panel 11 may display an image whose gradient cannot be fixed depending on the displayed position on screen even though it displays image data having the same gradient; hence, users may visually recognize irregularity while watching the display face of the image display device 1.

Even when the backlight 12 emits uniform quantity of light, users may visually recognize images at different gradients since the transmissivity for each pixel may differ depending on the degree of degradation.

Therefore, the display panel control table shows the correlation between cumulated quantities of light and driving conditions of the display panel 11 in consideration of worst characteristics of degradation in the TFTs 111. The present embodiment is designed to change the driving conditions of TFTs 111 at all the pixels on the display panel 11 with reference to the display panel control table.

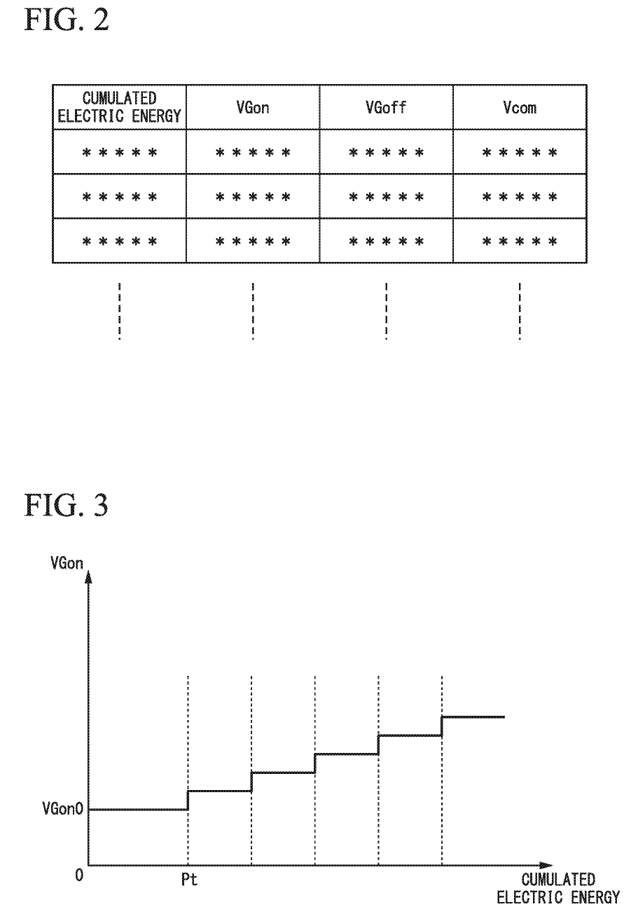

FIG. 2 shows an example of the configuration of a display panel control table stored on the storage unit 15. The display panel control table shows gate-on voltage VGon, gate-off voltage VGoff, and common-electrode voltage Vcom in relation to cumulated electric energy. The gate-on voltage VGon indicates the level of voltage applied to the gate electrode of the TFT 111 to turn on. The gate-off voltage VGoff indicates the level of voltage applied to the gate electrode of the TFT 111 to turn off. The common-electrode voltage Vcom indicates the level of voltage applied to a common electrode of the display panel 21.

The gate-on voltage VGon is increased depending on the degree of degradation of the TFT 111 described above, e.g. the increased threshold voltage of the TFT 111, the increased resistance, or the like. The gate-off voltage VGoff is increased in response to an increment of the gate-on voltage VGon. Due to the increased threshold of the TFT 111, the TFT 111 will be turned off even when the gate-off voltage VGoff is increased. The common-electrode voltage Vcom is set in correspondence with a difference between an increment of the gate-on voltage VGon and an increment of the gate-off voltage VGoff.

Due to a parasitic capacity between pixels when a gate voltage applied to a gate electrode of the TFT 111 corresponding to one pixel is changed from the gate-on voltage VGon to the gate-off voltage VGoff, a voltage change may affect a pixel electrode of another pixel adjacent to one pixel so as to increase the voltage applied to the pixel electrode of another pixel. The voltage being changed at the pixel electrode of another pixel under the influence of the voltage at the electrode of its adjacent pixel is defined as a punch-through voltage ΔVg.

The punch-through voltage ΔVg may apply a dc voltage to a liquid-crystal layer of the display panel 11; hence, it may decrease the lifetime of liquid crystal or it may reduce picture quality due to flickering. In addition, the punch-through voltage ΔVg is increased in proportion to a difference between an increment of the gate-on voltage VGon and an increment of the gate-off voltage VGoff. For this reason, the punch-through voltage ΔVg is increased by an increment of the gate-on voltage VGon while the punch-through voltage ΔVg is decreased by an increment of the gate-off voltage VGoff.

Therefore, it is preferable to match an increment of the gate-off voltage VGoff with an increment of the gate-on voltage VGon. However, it is impossible to match those increments with each other due to another problem occurs when the TFT 111 cannot be completely turned off. To cancel off an increment of the punch-through voltage ΔVg which is increased in response to a difference between an increment of the gate-on voltage VGon and an increment of the gate-off voltage VGoff, it is preferable to decrease the common-electrode voltage Vcom in connection with pixel electrodes.

FIG. 3 is a graph showing the correlation between the cumulated electric energy and the gate-on voltage VGon. In FIG. 3, the horizontal axis represents the cumulated electric energy (Pw) while the horizontal axis represents the gate-on voltage VGon of the TFT 111. A gate-on voltage VGon0 serving as a gate-applied voltage is continuously used until the cumulated electric energy Pt. The gate-on voltage GVon0 is a threshold voltage for the TFTs 111 of the image display device 1 in the setting for shipment.

In the above, the cumulated electric energy Pt is set based on the cumulative value of the quantity of irradiated light (i.e. cumulated light quantity) to the extent that users watching images on screen should not visually recognize irregularities on screen due to dispersions of degradation occurring on the TFTs 111 in the display panel 11. By using driving conditions for shipment, it is possible to control the transmissivity for the TFTs 111 of the display panel 11 in a certain degree of degradation occurring on the TFTs 111 without causing visually-recognizable irregularities on screen as long as the cumulated electric energy is equal to or below the cumulated electric energy Pt.

That is, it is possible to control the transmissivity for each pixel on the display panel 11 by use of the gate-on voltage VGon in relation to the cumulated electric energy corresponding to a certain degree of degradation that users watching images on screen should not visually recognize irregularities on screen. When the cumulated electric energy exceeds the cumulated electric energy Pt, the worst characteristics of TFTs 111 will be significantly degraded in comparison with the characteristics of other TFTs 111 (due to the increased threshold voltage or the increased ON-resistance) irrespective of the gate-on voltage VGon0, which in turn causes differences of transmissivity between pixels to be larger than tolerances set to specifications, and therefore users watching images on screen may visually recognize irregularities on screen.

As shown in FIG. 3, the display panel control table of FIG. 2 divides the entirety of cumulated electric energy into multiple ranges so as to set the gate-on voltage VGon depending on the degree of degradation for each range of cumulated electric energy. Therefore, it is possible to improve the precision of correcting the driving condition of the display panel 11 due to degradation by increasing the number of divisions for the cumulated electric energy. Upon using the table of FIG. 2 for controlling, the display pane controller 13 (see FIG. 1) reads a cumulative value of electric energy from the cumulative quantity calculation part 14. Subsequently, the display panel controller 13 reads the driving condition of the display panel 11 corresponding to the read value of cumulated electric energy (e.g. the gate-on voltage VGon, the gate-off voltage VGoff, and the common electrode voltage Vcom) from the display panel control table of the storage unit 15, thus controlling the TFTs 111 in the display panel 11.

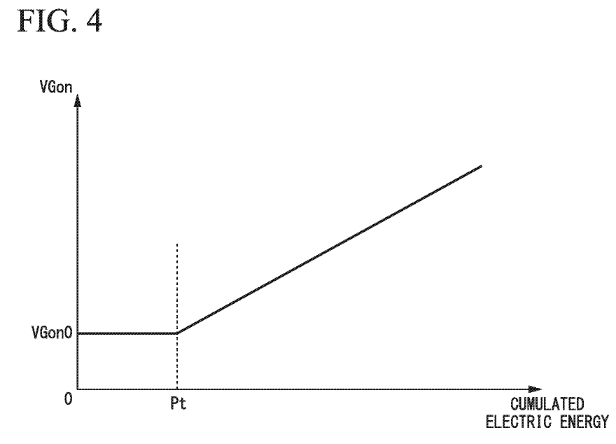

FIG. 4 is another graph showing the correlation between the cumulated electric energy and the gate-on voltage VGon. In FIG. 4, the horizontal axis represents the cumulated electric energy (Pw) while the vertical axis represents the gate-on voltage VGon for TFTs 111. Similar to the graph of FIG. 3, the gate-on voltage VGon0 is used as a gate-applied voltage in the initial range up to the cumulated electric energy Pt. In addition, FIG. 4 shows the linear relationship (i.e. values plotted on a straight line) between the gate-on voltage VGon and the cumulated electric energy following the cumulated electric energy Pt.

In order to control the gate-on voltage VGon to be linearly proportion to the cumulated electric energy, as show in FIG. 4, the display panel controller 13 reads a neighboring value of cumulated electric energy close to the read value of cumulated electric energy from the display panel control table so as to calculate the gate-on voltage VGon, corresponding to the read value of cumulated electric energy, by way of interpolation based on the neighboring value of cumulated electric energy and its corresponding gate-on voltage VGon. In addition, the display panel controller 13 calculates the gate-off voltage VGoff and the common electrode voltage Vcom by way of interpolation based on their neighboring values of cumulated electric energy.

To control the gate-on voltage VGon to be linearly proportion to the cumulated electric energy, as shown in FIG. 4, it is possible to write and store experimental equations representing the linear relationship shown in FIG. 3, instead of the display panel control table of FIG. 2, on the storage unit 15. In this configuration, the display panel controller 13 (see FIG. 1) reads a value of cumulated electric energy from the cumulative quantity calculation part 14 while reading the experimental equation from the storage unit 15. Then, the display panel controller 13 calculates the gate-on voltage VGon by assigning the value of cumulated electric energy to an experimental equation, thus controlling the TFTs 111 in the display panel 11. At this time, the display panel controller 13 may calculate the gate-on voltage VGoff and the common electrode voltage Vcom by assigning the value of cumulated electric energy to another experimental equation.

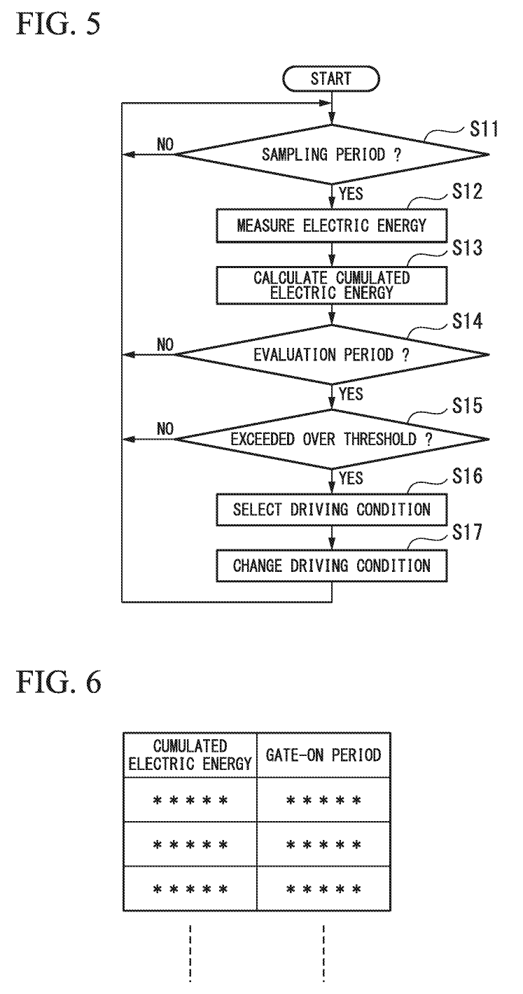

FIG. 5 is a flowchart showing an example of a procedure for driving the display panel 11 with the image display device 1.

Step S11:

The electric energy detector 16 determines whether or not the current timing matches a sampling period for calculating power that the emission controller 17 supplies to the backlight 12 by detecting a count value of an internal timer. When the count value of an internal timer indicates a sampling period, the electric energy detector 16 proceeds to step S12. When the count value of an internal timer does not indicate a sampling period, the electric energy detector 16 repeats the step S11.

Step S12:

The electric energy detector 16 measures a current and a voltage that the emission controller 17 supplies to the backlight 12 so as to calculate electric energy based on the current and the voltage (i.e. average electric energy for a sampling period). Then, the electric energy detector 16 sends the calculated value of electric energy to the cumulative quantity calculation part 14.

Step S13:

The electric energy detector 16 supplies a value of electric energy to the cumulative quantity calculation part 14, which in turn reads a value of cumulated electric energy stored in an internal storage unit. Then, the cumulative quantity calculation part 14 sums up the supplied value of electric energy and the read value of cumulated electric energy so as to write and store the addition result on the internal storage unit as a new value of cumulated electric energy.

Thereafter, the cumulative quantity calculation part 14 notifies the display panel controller 13 of an event of updating the cumulated electric energy.

Step S14:

Upon receiving a notice that the cumulated electric energy is updated from the cumulative quantity calculation part 14, the display panel controller 13 determines whether or not the count value of an internal timer exceeds an evaluation period. The display panel controller 13 proceeds to step S15 when the count value of an internal timer exceeds the evaluation period. On the other hand, the display panel controller 13 proceeds to step S11 when the count value of an internal timer does not exceed the evaluation period.

Step S15:

The display panel controller 13 reads a value of cumulated electric energy from the internal storage unit of the cumulative quantity calculation part 14. Then, the display panel controller 13 determines whether or not the read value of cumulated electric energy exceeds the threshold representing the cumulated electric energy Pt.

The display panel controller 13 proceeds to step S16 when the read value of cumulated electric energy exceeds the threshold representing the cumulated electric energy Pt. On the other hand, the display panel controller 13 proceeds to step S11 when the read value of cumulated electric energy does not exceed the threshold representing the cumulated electric energy Pt.

Step S16:

The display panel controller 13 reads a driving condition for the display panel 11 corresponding to the read value of cumulated electric energy (i.e. the gate-on voltage VGon, the gate-off voltage VGoff, and the common electrode voltage Vcom) from the display panel control table stored on the storage unit. Then, the display panel controller 13 selects the read driving condition for the display panel 11 as a new driving condition for the display panel 11 afterwards.

Step S17:

Thereafter, the display panel controller 13 drives the display panel 11 based on the selected driving condition.

As described above, the present embodiment calculates the cumulated electric energy by cumulating electric energy supplied to the backlight 12 for its illumination so as to estimate the cumulated quantity of light being irradiated to the TFTs 111 until the current timing based on the calculated value of cumulated electric energy. Thus, the present embodiment drives the display panel 11 while changing its driving condition depending on the degree of degradation occurred in the TFTs 111 having worst characteristics of degradation corresponding to the estimated value of cumulated electric energy. For this reason, the present embodiment is able to eliminate differences of transmissivity among pixels on the display screen due to dispersions in the degree of degradation occurring in the TFTs 111, and therefore it is possible to prevent users watching images on screen from visually recognizing irregularities on the display screen.

In addition, the present embodiment changes the level of the gate-on voltage VGon for controlling the TFT 111 depending on the cumulated electric energy. However, it is possible to change the gate-on period instead of changing the level of the gate-on voltage VGon.

FIG. 6 shows another configuration of the display panel control table stored on the storage unit 15. The display panel control table describes the gate-on time, i.e. the time of applying the gate-on voltage VGon to the gate of each TFT 111, in connection with the cumulated electric energy.

The above configuration increases the time of turning on the TFT 111 each time the TFT 111 is degraded in its property in relation to the degree of degradation occurring on the TFT 111, and therefore it is possible to supply charges realizing adequate transmissivity for each pixel on the display panel 11. According to the present embodiment, it is possible to eliminate differences of transmissivity among pixels on the display screen due to dispersions in the degree of degradation occurring in the TFTs 111, and therefore it is possible to prevent users watching images on screen from visually recognizing irregularities on the display screen.

### Second Embodiment

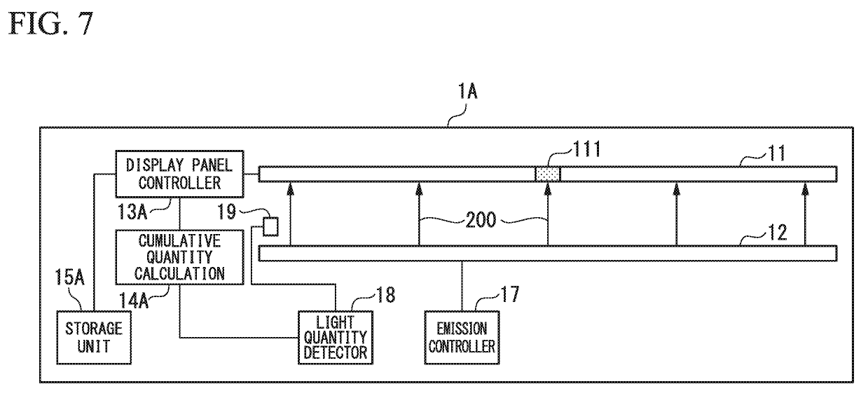

Hereinafter, an image display device according to the second embodiment of the present invention will be described with reference to the drawings. FIG. 7 shows an example of the configuration of the image display device 1A according to the second embodiment of the present invention. As shown in FIG. 7, the image display device 1A includes the display panel 11, the backlight 12, a display panel controller 13A, a cumulative quantity calculation part 14A, a storage unit 15A, the emission controller 17, a light quantity detector 18, and an optical sensor 19.

In FIG. 7, parts similar to those of the first embodiment shown in FIG. 1 are denoted using the same reference signs. Thus, different points than the first embodiment will be described below.

The optical sensor 19 detects the luminance of light that the backlight 12 irradiates to the rear face of the display panel 11.

The light quantity detector 18 inputs the luminance detected by the optical sensor 19 (in the unit of nit: candela for each square meter). The light quantity detector 18 carries out a calculation to multiply the input value of luminance by a sampling period of time (h), thus sending the calculation result, i.e. the light quantity for each sampling period (nit·h), to the cumulative quantity calculation part 14A.

The cumulative quantity calculation part 14A sums up (or cumulates) the light quantity of the backlight 12, which is supplied from the light quantity detector 18 for each sampling period, so as to write and store the cumulative result in the internal storage unit as the cumulated light quantity.

The display panel controller 13A reads the cumulated light quantity from the storage unit of the cumulative quantity calculation part 14 for each evaluation period so as to control the transmissivity for each pixel on the display panel 11 based on the cumulated light quantity.

According to the present embodiment described above, the cumulative quantity calculation part 14A calculates the cumulated light quantity. The cumulated light quantity is produced by cumulating the light quantity representing the amount of light that the backlight 12 irradiates to the rear face of the display panel 11 under the control of the emission controller 17.

A display panel control table showing the correlation between the cumulated light quantity and the driving condition for the display panel 11 having the TFTs 111 driven by the cumulated light quantity is written into and stored on the storage unit 15A in advance. As described above, the cumulated light quantity represents the cumulated amount of light irradiated to the display panel 11 having the TFTs 111, and therefore the cumulated light quantity corresponds to stress occurring on the TFTs 111.

For this reason, acceleration experiments are carried out to measure the characteristics of the TFTs 111 in earliest degradation due to dispersions of processes, and therefore the display panel control table is produced in consideration of the worst characteristics of the TFTs 111.

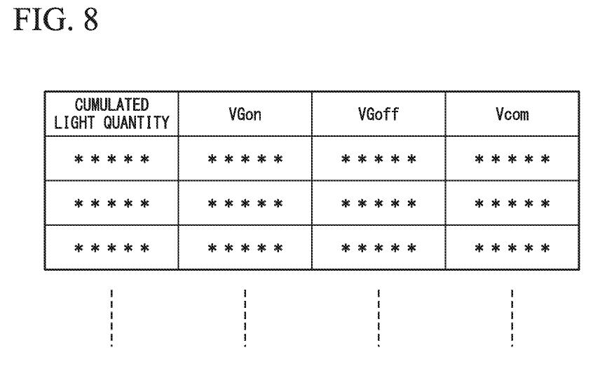

FIG. 8 shows an example of the configuration of the display panel control table stored on the storage unit 15A. The display panel control table describes the gate-on voltage VGon, the gate-off voltage VGoff, the common electrode voltage Vcom in connection with the cumulated value of emission. The gate-on voltage VGon represents the level of voltage applied to the gate electrode of each TFT 111 to turn on.

The gate-off voltage VGoff represents the level of voltage applied to the gate electrode of each TFT 111 to turn off. The common electrode voltage Vcom represents the level of voltage applied to a common electrode. FIG. 8 shows the gate-on voltage VGon, the gate-off voltage VGoff, and the common electrode voltage Vcom similar to those described in FIG. 2.

According to the display panel control table of the present embodiment, the correlation between the cumulated light quantity and the gate-on voltage VGon is similar to the correlation between the cumulated light quantity and the gate-on voltage VGon as described in the first embodiment; hence, values of emission and voltages are determined in a stepwise manner. Thus, it is possible to actually calculate the gate-on voltage VGon corresponding to the cumulated light quantity by way of interpolation based on the relationship between the gate-on voltage VGon and the cumulated value of emission being varied in a stepwise manner. That is, the display panel controller 13A reads the neighboring value of cumulated light quantity close to the input value of cumulated light quantity from the display panel control table so as to calculate the gate-on voltage VGon corresponding to the input value of cumulated light quantity by way of interpolation based on the gate-on voltage VGon corresponding to the neighboring value of cumulated light quantity. In addition, the display panel controller 13A calculates the gate-off voltage VGoff and the common electrode voltage Vcom by way of interpolation based on the neighboring value of cumulated light quantity.

Similar to FIG. 3 showing the linear correlation, it is possible to write and store experimental equations representing the correlation between the cumulated light quantity and the gate-on voltage VGon in advance. In this case, the display panel controller 13A (see FIG. 7) reads the cumulated light quantity from the cumulative quantity calculation part 14A while reading experimental equations from the storage unit 15A. Then, the display panel controller 13A calculates the gate-on time by assigning the cumulated light quantity to an experimental equation, thus controlling the TFTs 111 of the display panel 11. In addition, the display panel controller 13A calculates the gate-off voltage VGoff and the common electrode voltage Vcom by assigning the cumulated light quantity to another experimental equation.

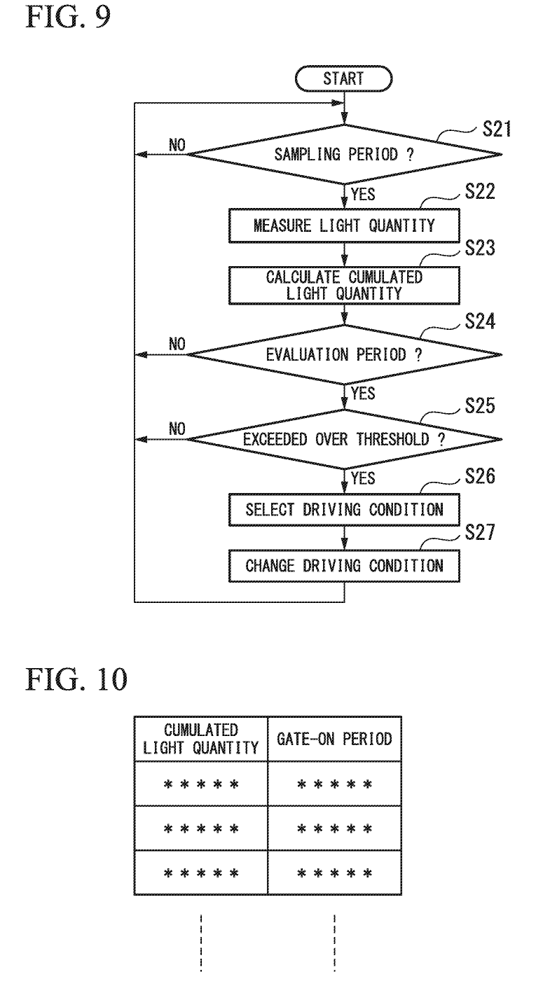

FIG. 9 is a flowchart showing an example of a procedure for driving the display panel 11 with the image display device 1A.

Step S21:

The light quantity detector 18 determines whether or not the current timing matches a sampling period of calculating the light quantity representing the light irradiated to the display panel 11 by the backlight 12 by detecting the count value of an internal timer. When the count value of an internal timer indicates a sampling period, the light quantity detector 18 proceeds to step S22. On the other hand, when the count value of an internal timer does not indicate a sampling period, the light quantity detector 18 repeats the step S21.

Step S22:

The light quantity detector 18 reads the luminance of light that the backlight 12 irradiates to the display panel 11 by means of the optical sensor 19 and then multiplies the luminance of light by a sampling period of time so as to produce the light quantity (i.e. the average light quantity for each sampling period). Then, the light quantity detector 18 sends the calculated value of light quantity to the cumulative quantity calculation part 14A.

Step S23:

Upon receiving the light quantity supplied from the light quantity detector 18, the cumulative quantity calculation part 14A reads the cumulated light quantity stored on an internal storage unit. Then, the cumulative quantity calculation part 14A sums up the supplied value of light quantity and the read value of cumulated light quantity so as to write and store the addition result on the internal storage unit as new cumulated light quantity.

Thereafter, the cumulative quantity calculation part 14A notifies the display panel controller 13A of an event of updating the cumulated light quantity.

Step S24:

Upon receiving a notice of updating the cumulated light quantity from the cumulative quantity calculation part 14A, the display panel controller 13A determines whether or not the count value of an internal timer exceed the evaluation period. When the count value of an internal timer exceeds the evaluation period, the display panel controller 13A proceeds to step S25. On the other hand, when the count value of an internal timer does not exceed the evaluation period, the display panel controller 13A proceeds to step S21.

Step S25:

The display panel controller 13A reads the cumulated light quantity from the internal storage unit of the cumulative quantity calculation part 14A. Then, the display panel controller 13A determines whether or not the read value of cumulated light quantity exceeds a threshold of cumulated light quantity lt (corresponding to the threshold representing the cumulated electric energy Pt in the first embodiment).

When the read value of cumulated light quantity exceeds the threshold of cumulated light quantity lt, the display panel controller 13A proceeds to step S26. On the other hand, when the read value of cumulated light quantity does not exceeds the threshold of cumulated light quantity lt, the display panel controller 13A proceeds to step S21.

Step S26:

The display panel controller 13A reads the driving condition of the display panel 11 corresponding to the read value of cumulated light quantity (i.e. the gate-on voltage VGon, the gate-off voltage VGoff, and the common electrode voltage Vcom) from the display panel control table stored on the storage unit 15A. Then, the display panel controller 13A selects the read driving condition of the display panel 11 as the new driving condition of the display panel 11 afterwards.

Step S27:

The display panel controller 13A drives the display panel 11 afterwards based on the selected driving condition.

As described above, the present embodiment sums up the light quantity representing the amount of light that the backlight 12 irradiates to the display panel 11 so as to calculate the cumulated light quantity until the present timing. The present embodiment drives the display panel 11 while changing its driving condition depending on the degree of degradation occurring in the TFTs 111 having worst characteristics of degradation corresponding to the estimated value of cumulated light quantity. Thus, the present embodiment is able to eliminate differences of transmissivity among pixels on the display screen due to dispersions in the degree of degradation occurring on the TFTs 111, and therefore it is possible to prevent users watching images on screen from visually recognizing irregularities on the display screen.

In addition, the present embodiment changes the level of the gate-on voltage VGon for controlling each TFT 111 based on the cumulated light quantity. However, it is possible to change the gate-on time instead of changing the level of the gate-on voltage VGon.

FIG. 10 shows another example of the configuration of the display panel control table stored on the storage unit 15A. The display panel control table describes the gate-on time, representing the time of applying the gate-on voltage VGon to the gate of each TFT 111, in connection with the cumulated light quantity. The gate-on time indicates a period of turning on the TFT 111.

The above configuration is designed to increase the time of turning on the TFT 111 each time the TFT 111 is degraded in its property in relation to the degree of degradation occurring on the TFT 111, and therefore it is possible to supply charges realizing adequate transmissivity for each pixel of the display panel 11. Thus, the present embodiment is able to eliminate differences of transmissivity among pixels on the display screen due to dispersions in the degree of degradation occurring on the TFTs 111, and therefore it is possible to prevent users watching images on screen from visually recognizing irregularities on the display screen.

### Third Embodiment

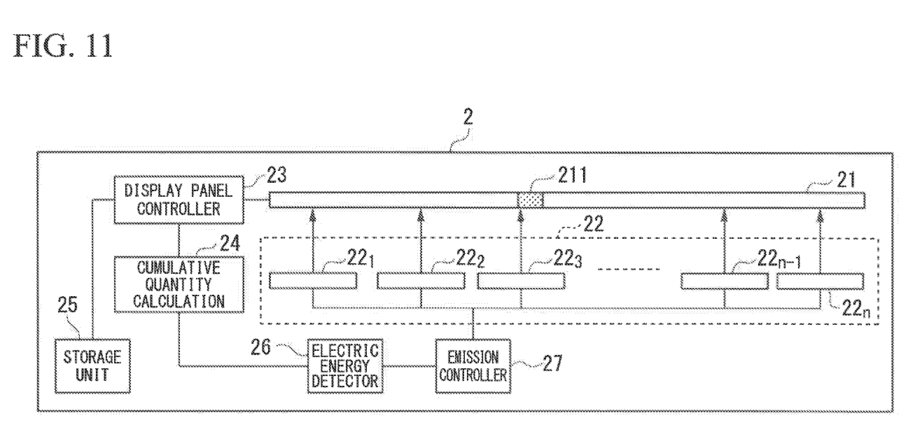

Hereinafter, an image display device according to the third embodiment of the present invention will be described with reference to the drawings. FIG. 11 shows an example of the configuration of the image display device 2 according to the third embodiment of the present invention. As shown in FIG. 11, the image display device 2 includes a display panel 21, a backlight 22, a display panel controller 23, a cumulative quantity calculation part 24, a storage unit 25, an emission controller 27, and an light quantity detector 28. The image display device 2 of the present embodiment operates upon the local dimming of the backlight 22.

The local dimming is realized by dividing the pixels of the display panel 21 into groups of pixel areas (or pixel blocks) each including a plurality of pixels so as to locally control the luminance of light irradiated to those pixel areas by use of sub-backlights (or light-source blocks), which will be discussed later. That is, the local dimming is able to control the light quantity for each sub-backlight corresponding to each pixel area depending on the gradient of an image displayed on each pixel area. For this reason, it is possible to adjust sub-backlights by reducing the luminance of light irradiated to pixel areas depending on their gradients, and therefore it is possible to reduce power consumption by reducing the amount of unwanted light. In addition, it is possible to reduce the luminance of light irradiated to a relatively dark pixel area, i.e. a pixel area for displaying an image not having a high gradient. By suppressing unwanted light, it is possible to improve the contrast for each pixel area having high luminance, thus broadening the dynamic range.

For example, the display panel 21 is a liquid crystal panel, which is designed to control the transmissivity for each pixel in liquid crystal by means of TFTs 211. Similar to the foregoing TFTs 111, the TFTs 211 are provided for pixels so as to carry out charging for storing charges in each pixel capacity of liquid crystal or discharging for releasing charges. The TFTs 211 are field-effect transistors. Thus, it is possible to control the transmissivity for pixels of the display panel 21 based on the amount of charges stored in pixel capacities.

The backlight 22 is disposed on the rear face opposite to the front face of the display panel 21. For example, the backlight 22 is formed using light-emitting elements such as LEDs so as to irradiate light 200 to the rear face of the display panel 21 with desired luminance. For the sake of a plurality of pixel areas that are formed by dividing the pixels of the display panel 21, the backlight 22 includes sub-backlights 22₁ to 22ₙ that are used to irradiate light to the divided pixel areas with their values of luminance.

The emission controller 27 controls the sub-backlights 22₁ to 22ₙ so as to emit light, having luminance corresponding to image data (or gradient) for each pixel area, towards their irradiation targets. At this time, the emission controller 17 supplies power to the sub-backlights 22₁ to 22ₙ for their emission of light while setting a predetermined value as the luminance of light emitted by the sub-backlights 22₁ to 22ₙ.

The electric energy detector 26 calculates electric energy that the emission controller 27 supplies to the sub-backlights 22₁ to 22ₙ based on a current value and a voltage value output from the emission controller 27 for each predetermined sampling period, thus sending the calculated value of electric energy to the cumulative quantity calculation part 24. That is, the electric energy detector 26 multiplies a current value α (A) and a voltage value β (V) supplied to each of the sub-backlights 22₁ to 22ₙ so as to produce power αβ(W) for each of the sub-backlights 22₁ to 22ₙ.

Subsequently, the electric energy detector 26 multiplies the power αβ(W) for each of the sub-backlights 22₁ to 22ₙ by a sampling period of time (h) so as to produce electric energy (Wh) for each sampling period with respect to each of the sub-backlights 22₁ to 22ₙ.

The cumulative quantity calculation part 24 sums up (or cumulates) electric energy supplied to each of the sub-backlights 22₁ to 22ₙ for each predetermined sampling period so as to write and store the cumulative result on an internal storage unit as the cumulated electric energy for each of the sub-backlights 22₁ to 22ₙ.

The display panel controller 23 reads the maximum value of cumulated electric energy from the storage unit of the cumulative quantity calculation part 24 for each evaluation period so as to control the transmissivity for the pixels of the display panel 21 based on the maximum value of cumulated electric energy. That is, the sub-backlight 22ᵢ (1≦i≦n) irradiate the highest amount of light to its corresponding pixel area on the display panel 21, in other words, it causes stress on the TFTs 211 in the pixel area. Therefore, the display panel controller 23 controls the pixel areas of the display panel 21 based on the driving condition corresponding to the maximum value of cumulate electric energy.

In the present embodiment as described above, the cumulative quantity calculation part 24 calculates the cumulated electric energy for each sub-backlight 22ᵢ.

The cumulated electric energy is produced by cumulating power that the emission controller 27 supplies to each sub-backlight 22ᵢ of the backlight 22 for its emission of light; hence, the cumulated electric energy would be substantially equivalent to the cumulated light quantity representing the quantity of light irradiated by each sub-backlight 22ᵢ. That is, the emission controller 27 sequentially changes electric energy in a stepwise manner and supplies electric energy to each sub-backlight 22ᵢ of the backlight 22, and therefore the amount of light in each step is measured as the quantity of emission; hence, it is possible to determine the correlation between electric energy and light quantity. Based on the correlation, it is possible to easily calculate electric energy corresponding to light quantity.

Similar to the display panel control table of FIG. 2, the correlation between the cumulated electric energy and the driving condition for the display panel 21 including the TFTs 211 is written into and stored on the storage unit 25 in advance. The cumulated light quantity represents the cumulated quantity of light irradiated to the TFTs 211 of the display panel 21; hence, the cumulated light quantity may correspond to stress occurred on the TFTs 211.

For this reason, acceleration experiments are carried out to select the characteristics of the TFTs 211 in earliest degradation due to dispersions of processes among the TFTs of the display panel 21, and therefore the display panel control table is produced in correspondence with the worst characteristics of the TFTs 211.

The reason why the present embodiment selects the backlight 22ᵢ having the highest value of cumulated light quantity is that different pixel areas corresponding to different sub-backlights 22ᵢ suffer from different degrees of degradation since different sub-backlights 22ᵢ produce different quantities of cumulated irradiation. For this reason, the present embodiment controls the display panel 21 by adjusting the driving condition on the entirety of the display panel 21 to the driving condition of the TFTs 211 in the pixel area corresponding to the sub-backlight being rapidly degraded due to highest stress, i.e. the sub-backlight producing the highest quantity of cumulate emission.

This is because the transmissivity for the pixel area being rapidly degraded due to the highest value of cumulated light quantity differs from the transmissivity for the pixel area being slowly degraded due to a relatively low value of cumulated light quantity with respect to image data having the same gradient. For this reason, images are displayed with inconstant gradients depending display positions on the display panel 21 even when image data having the same gradient are displayed on the display panel 21, and therefore users watching the display screen of the image display device 2 should visually recognize irregularities on the display screen.

Thus, users may visually recognize images with different gradients due to different transmissivities of pixel areas depending on their degrees of degradation even when the backlight 22 irradiates light to the display panel 21 with the constant light quantity. In addition, the display panel control table describes the relationship between the cumulated light quantity and the driving condition of the display panel 21 in consideration of the worst characteristics of degradation for the TFTs 211 in the display panel 21 since it is uncertain which pixel area includes the TFTs 211 having the worst characteristics of degradation. The present embodiment is designed to change the driving condition for the TFTS 211 corresponding to all the pixels of the pixel areas on the display panel 21 in correspondence with the display panel control table.

As described in the first embodiment in conjunction with FIG. 3, the entire range of the cumulated electric energy is divided into multiple ranges, and therefore the gate-on voltage VGon is set depending on the degree of degradation for each range of cumulated electric energy with the display panel control table of FIG. 2. Therefore, it is possible to improve the precision for correcting the driving condition of the display panel 21 depending on the degree of degradation by increasing the number of divisions for the cumulated electric energy. Using the table of FIG. 2 for controlling, the display panel controller 23 (see FIG. 11) reads the maximum value of cumulated electric energy from the cumulative quantity calculation part 24. Subsequently, the display panel controller 23 reads the driving condition of the display panel 21 corresponding to the maximum value of cumulated electric energy (i.e. the gate-on voltage VGon, the gate-off voltage VGoff, and the common electrode voltage Vcom) from the display panel control table of the storage unit 25 so as to control the TFTs 211 of the display panel 21.

As described in the first embodiment in conjunction with FIG. 4, in order to control the gate-on voltage VGon linearly along with the cumulated electric energy, the display panel controller 23 selects the neighboring value of cumulated electric energy close the maximum value of cumulated electric energy from the display panel control table so as to calculate the gate-on voltage VGon corresponding to the maximum value of cumulated electric energy by way of interpolation based on the relationship between the neighboring value of cumulated electric energy and its corresponding gate-on voltage VGon. In addition, the display panel controller 23 calculates the gate-off voltage VGoff and the common electrode voltage Vcom by way of interpolation based on the neighboring value of cumulated electric energy.

To control the gate-on voltage VGon linearly along with the cumulated electric energy as shown in FIG. 4, it is possible to write and store experimental equations representing the linear relationship shown in FIG. 3, instead of the display panel control table of FIG. 2, on the storage unit 25. In this case, the display panel controller 23 reads the maximum value of cumulated electric energy from the cumulative quantity calculation part 24 while reading the experimental equations from the storage unit 25. Then, the display panel controller 23 assigns the cumulated electric energy to an experimental equation so as to calculate the gate-on voltage VGon, thus controlling the TFTs 211 in the pixel areas of the display panel 21. In addition, the display panel controller 23 calculates the gate-off voltage VGoff and the common electrode voltage Vcom by assigning the cumulated electric energy to another experimental equation.

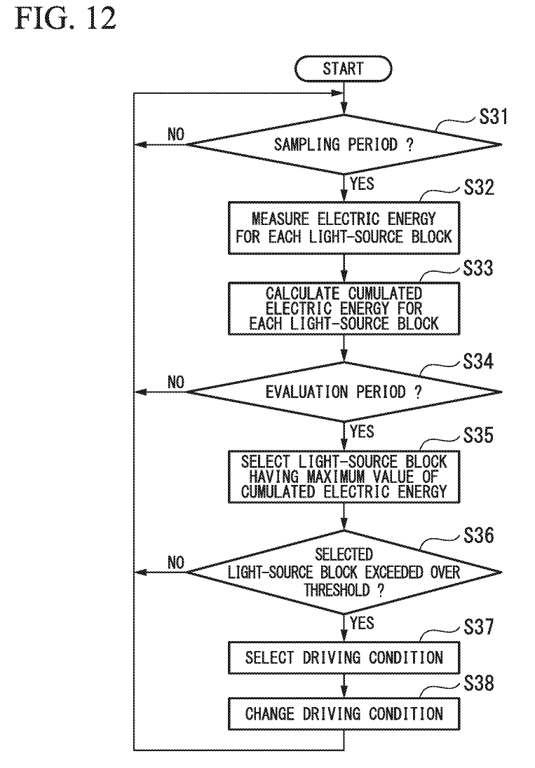

FIG. 12 is a flowchart showing an example of a procedure for driving the display panel 21 with the image display device 2.

Step S31:

The electric energy detector 26 determines whether or not the current timing is a sampling period for calculating electric energy that the emission controller 27 supplies to the sub-backlights 22i of the backlight 22 by detecting the count value of an internal timer. When the count value of the timer indicates the sampling period, the electric energy detector 26 proceeds to step S32. When the count value of the timer does not indicate the sampling period, the electric energy detector 26 repeats the step S31.

Step S32:

The electric energy detector 26 measures a current value and a voltage value that the emission controller 27 supplies to each sub-backlight 22i of the backlight 22 so as to calculate electric energy for each sub-backlight 22i based on the current value and the voltage value (i.e. average electric energy for each sampling period). Then, the electric energy detector 16 sends the electric energy for each sub-backlight 22i to the cumulative quantity calculation part 24.

Step S33:

Upon receiving the electric energy supplied from the electric energy detector 26, the cumulative value calculation part 24 reads the cumulated electric energy from the internal storage unit with respect to each of the sub-backlights 22ᵢ. Subsequently, the cumulative quantity calculation part 24 sums up the supplied electric energy and the cumulated electric energy with respect to each sub-backlight 22ᵢ so as to write and store the addition result on the internal storage unit as new cumulated electric energy with respect to each sub-backlight 22ᵢ.

Then, the cumulative value calculation part 24 notifies the display panel controller 23 of an event of updating the cumulated electric energy for each sub-backlight 22ᵢ.

Step S34:

Upon receiving a notice of the cumulative quantity calculation part 24 that the cumulated electric energy is updated with respect to each sub-backlight 22ᵢ, the display panel controller 23 determines whether or not the count value of the internal timer exceeds the evaluation period. When the count value of the internal timer exceeds the evaluation period, the display panel controller 23 proceeds to step S35. When the count value of the internal timer does not exceed the evaluation period, the display panel controller 23 proceeds to step S31.

Step S35:

The display panel controller 23 extracts and reads the maximum value of cumulated electric energy among the sub-backlights 22₁ to 22ₙ stored on the internal storage unit.

Step S36:

Then, the display panel controller 23 determines whether or not the maximum value of cumulated electric energy exceeds the threshold of cumulated electric energy Pt.

When the maximum value of cumulated electric energy exceeds the threshold of cumulated electric energy Pt, the display panel controller 23 proceeds to step S36. When the maximum value of cumulated electric energy does not exceed the threshold of cumulated electric energy Pt, the display panel controller 23 proceeds to step S31.

Step S37:

The display panel controller 23 selects the driving condition for the display panel 21 corresponding to the maximum value of cumulated electric energy (i.e. the gate-on voltage VGon, the gate-off voltage VGoff, and the common electrode voltage Vcom) with reference to the display panel control table stored on the storage unit 25. Subsequently, the display panel controller 23 determines the selected driving condition for the display panel 21 as the new driving condition for the display panel 21 afterwards.

Step S38:

The display panel controller 23 drives the display panel 21 based on the selected driving condition afterwards.

As described above, the present embodiment sums up the amount of electric energy used for light emission with each sub-backlight 22ᵢ of the backlight 22 with respect to each sub-backlight 22ᵢ so as to calculate the amount of cumulated electric energy for each sub-backlight 22ᵢ. Based on the calculated value of cumulated electric energy, the present embodiment estimates the cumulated light quantity representing light irradiated to each pixel area of the display panel 21 by each sub-backlight 22ᵢ corresponding to each pixel area until the present time. In addition, the present embodiment selects the maximum value of cumulated light quantity from among the estimated values of cumulated light quantity for the sub-backlights 22ᵢ so as to drive the display panel 21 while changing the driving condition depending on the degree of degradation in the pixel area that is estimated to be highly degraded. For this reason, the present embodiment drives the display panel 21 based on the driving condition corresponding to the highly-degraded pixel area, and therefore it is possible to eliminate differences of transmissivity among pixel areas of the display panel 21, thus preventing users watching images on screen from visually recognizing irregularities on the display screen.

In addition, the present embodiment changes the level of the gate-on voltage VGon for controlling each TFT 211 on the display panel 21 based on the maximum value of cumulated electric energy. However, it is possible to change the gate-on period instead of the level of the gate-on voltage VGon.

Similar to the first embodiment, another example of the display panel control table of FIG. 6 is used to describe the gate-on period representing the time of applying the gate-on voltage VGon to the gate of each TFT 211 on the display panel 21 in connection with the maximum value of cumulated electric energy. The gate-on period represents the time of turning on the TFT 211.

The present embodiment employs local dimming so as to reduce the amount of unwanted light for each sub-backlight 22ᵢ depending on the displayed image, which in turn reduces power consumption. Thus, it is possible to reduce the cumulated light quantity with respect to the time of each user using the display panel 21. The present embodiment is able to reduce the quantity of light irradiated to each pixel area of the display panel 21 with the backlight 22, and therefore it is possible to significantly increase the life time of individual TFTs before their characteristics are degraded, thus increasing the life time of the display panel 21. Thus, it is possible to improve reliability for any image display devices serving as products using the display panel 21.

When each user displays a still image on the screen subjected to local dimming, differences of cumulated light quantity may differ from each other depending on the displayed image with respect to each sub-backlight 22ᵢ. Due to differences of cumulated light quantity representing the amount of light irradiated by each sub-backlight 22ᵢ, a significant difference will be observed between one pixel area having a relatively high degree of degradation and another pixel area having a relatively low degree of degradation among the pixel areas corresponding to the sub-backlights 22ᵢ, and therefore it may be visually recognized as irregularities on the display panel 21. The present embodiment is designed to calculate the cumulated light quantity for each sub-backlight 22ᵢ so as to correct the driving condition for each pixel area of the display panel 21 with an appropriate driving condition depending on the cumulated light quantity for each sub-backlight 22ᵢ irradiating light to each pixel area. This improves the correcting precision for correcting transmissivity depending on the degree of degradation, and therefore it is possible to effectively suppress the occurrence of irregularities among pixel areas of the display panel 21 displaying a still image under the influence of local dimming. As a result, the present embodiment is able to improve reliability concerning the display quality with respect to any image display devices adopting local dimming serving as products using the display panel 21.

### Fourth Embodiment

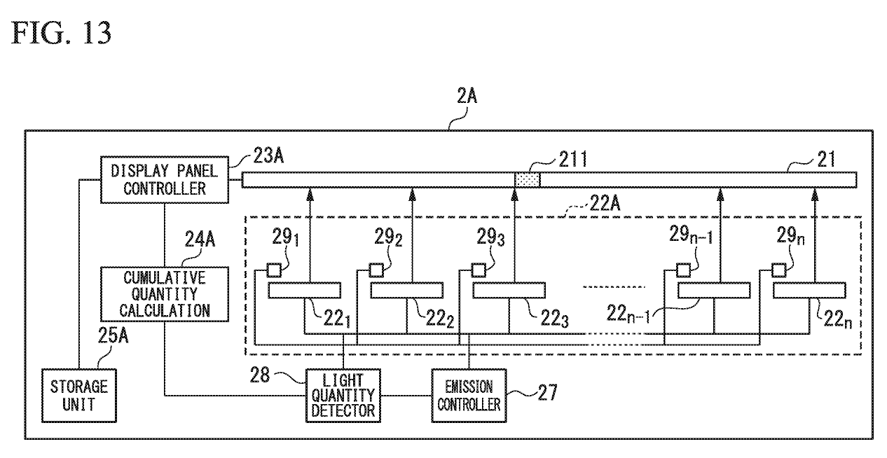

Hereinafter, an image display device according to the fourth embodiment of the present invention will be described with reference to the drawings. FIG. 13 shows an example of the configuration of the image display device 2A according to the fourth embodiment of the present invention. As shown in FIG. 13, the image display device 2A includes the display panel 21, a backlight 22A, a display panel controller 23A, a cumulative quantity calculation part 24A, a storage unit 25A, the emission controller 27, and the light quantity detector 28. The image display device 2A of the present embodiment is configured to operate the backlight 22A by way of local dimming.

In FIG. 13, parts identical to those of the third embodiment shown in FIG. 11 are denoted using the same reference signs. Thus, different points than the third embodiment will be described below.

Similar to the backlight 22 of the third embodiment, the backlight 22A includes a series of sub-backlights 22₁ to 22ₙ. In addition, the sub-backlights 22₁ to 22ₙ are equipped with optical sensors 19₁ to 19ₙ. The optical sensors 19₁ to 19ₙ detect values representing the luminance of light that the sub-backlights 22₁ to 22ₙ irradiate to their corresponding pixel areas. Thus, the optical sensors 19₁ to 19ₙ output measured values representing the luminance of light irradiated by the sub-backlights 22₁ to 22ₙ.

The light quantity detector 28 inputs the measured values representing the luminance of light (nit) detected by the optical sensors 19₁ to 19ₙ. Subsequently, the light quantity detector 28 multiplies the luminance value for each optical sensor 19ᵢ (where 1≦i≦n) by a sampling period of time so as to sequentially send calculation results to the cumulative quantity calculation part 24A as light quantity (nit·h) for each sub-backlight 22ᵢ in each sampling period with respect to each optical sensor 19ᵢ.

The cumulative quantity calculation part 24A sums up (or cumulates) light quantity for each sub-backlight 22ᵢ of the backlight 22 in each sampling period from the light quantity detector 28 with respect to each sub-backlight 22ᵢ so as to write and store the cumulative result on the internal storage unit as the cumulated light quantity that each sub-backlight 22ᵢ irradiates to its corresponding pixel area.

The display panel controller 23A reads the maximum value of cumulated light quantity among the cumulated light quantities of the sub-backlight 22₁ to 22ₙ from the storage unit of the cumulative quantity calculation part 24A for each evaluation period, thus controlling the transmissivity for each pixel on the display panel 21 based on the maximum value of cumulated light quantity.

According to the present embodiment as described above, the cumulative quantity calculation part 24A calculates cumulated light quantities with respect to the sub-backlights 22₁ to 22ₙ. The cumulated light quantities are produced by adding up emission quantities of light irradiated to the pixel areas of the display panel 21 with the backlight 22 having the sub-backlights 22₁ to 22ₙ that are controlled to emit light with luminance depending on image data of displayed pixels by the emission controller 27.

The display panel control table describing the correlation between the cumulated light quantity and the driving condition for the display panel 21 having the TFTs 211 at the cumulated light quantity is written into and stored on the storage unit 25A in advance. As described above, the cumulated light quantity represents the cumulated quantity of light irradiated to the pixel area of the display panel 21, and therefore it corresponds to stress occurring on the TFTs 211 in the pixel area.

For this reason, acceleration experiments are carried out to select the characteristics of TFTs 211 in earliest degradation due to dispersions in processes among the TFTs 211 of the display panel 21, and therefore the display panel control table is produced in correspondence with the worst characteristics of the TFTs 211.

Similar to the second embodiment, the present embodiment employs the display panel control table shown in FIG. 8. The display panel control table describes the gate-on voltage VGon, the gate-off voltage VGoff, and the common electrode voltage Vcom in connection with the cumulated light quantity. The gate-on voltage VGon represents the level of voltage applied to the gate electrode of each TFT 211 to turn on. The gate-off voltage VGoff represents the level of voltage applied to the TFT 211 to turn off. The common electrode voltage Vcom represents the level of voltage applied to the common electrode. In FIG. 8, the gate-on voltage VGon, the gate-off voltage VGoff, and the common electrode voltage Vcom have been described above in conjunction with FIG. 2.

Similar to the correlation between the cumulated electric energy and the gate-on voltage VGon in the first embodiment, the correlation between the cumulated light quantity and the gate-on voltage VGon is set in a stepwise manner in the display panel control table of the present embodiment. Based on the correlation between the cumulated light quantity and the gate-on voltage in a stepwise manner, it is possible to determine the gate-on voltage VGon relative to the input value of cumulated light quantity by way of interpolation. That is, the display panel controller 23A selects the neighboring value of cumulated light quantity close to the input value of cumulated light quantity with reference to the display panel control table so as to calculate the gate-on voltage VGon relative to the input value of cumulated light quantity by way of interpolation based on the gate-on voltage VGon corresponding to the neighboring value of cumulated light quantity. In addition, the display panel controller 23A calculates the gate-off voltage VGoff and the common electrode voltage Vcom by way of interpolation based on the neighboring value of cumulated light quantity.

As similar to the linear relationship shown in FIG. 3, it is possible to write and store experimental equations, representing the correlation between the cumulated light quantity and the gate-on voltage VGon, in advance. In this case, the display panel controller 23A (see FIG. 13) inputs the cumulated light quantity from the cumulative quantity calculation part 24A while reading experimental equations from the storage unit 25A. Subsequently, the display panel controller 23A assigns the cumulated light quantity to an experimental equation so as to calculate the gate-on voltage VGon, thus controlling the TFTs 211 of the display panel 21. In addition, the display panel controller 23A calculates the gate-off voltage VGoff and the common electrode voltage Vcom by assigning the cumulated light quantity to another experimental equation.

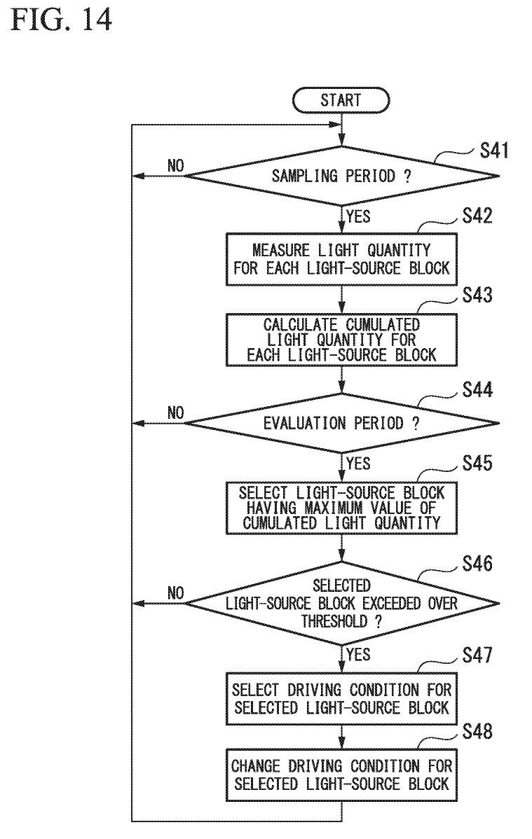

FIG. 14 is a flow chart showing an example of a procedure for driving the display panel 21 with the image display device 2A.

Step S41:

The light quantity detector 28 determines whether or not the current timing is a sampling period for calculating the quantity of light irradiated to each pixel area of the display panel 21 with each sub-backlight 22i of the backlight 22 by detecting the count value of an internal timer. When the count value of the timer indicates a sampling period, the light quantity detector 28 proceeds to step S42. When the count value of the timer does not indicate a sampling period, the light quantity detector 28 repeats the step S41.

Step S42:

The light quantity detector 28 reads from each optical sensor 19i installed in each sub-backlight 22ᵢ the luminance of light irradiated to each pixel area of the display panel 21 with each sub-backlight 22ᵢ of the backlight 22. Subsequently, the light quantity detector 28 multiplies the luminance of light irradiated by each sub-backlight 22ᵢ by a sampling period of time so as to produce the quantity of light with respect to each sub-backlight 22ᵢ (i.e. average quantity of light emission for each sampling period). Then, the light quantity detector 28 sequentially sends the calculated values of light quantity to the cumulative quantity calculation part 24A with respect to each sub-backlight 22ᵢ.

Step S43:

Upon receiving the light quantity of each sub-backlight 22ᵢ supplied from the light quantity detector 28, the cumulative quantity calculation part 24A reads the cumulated light quantity of each sub-backlight 22ᵢ stored on the internal storage unit. Subsequently, the cumulative quantity calculation part 24A sums up the supplied value of light quantity of each sub-backlight 22ᵢ and the read value of cumulated light quantity of each sub-backlight 22ᵢ so as to write and store the addition result on the internal storage unit as new cumulated light quantity with respect to each sub-backlight 22ᵢ.

Then, the cumulative quantity calculation part 24A notifies the display panel controller 23A of an event of updating the cumulated light quantity with respect to each sub-backlight 22ᵢ.

Step S44:

Upon receiving a notice that the cumulated light quantity is updated with respect to each sub-backlight 22i from the cumulative quantity calculation part 24A, the display panel controller 23A determines whether or not the count value of the internal timer exceeds an evaluation period. When the count value of the internal timer exceeds an evaluation period, the display panel controller 23A proceeds to step S45. When the count value of the internal timer does not exceed an evaluation period, the display panel controller 23A proceeds to step S41.

Step S45:

The display panel controller 23A selects and reads the maximum value of cumulated light quantity among the cumulated light quantities for the sub-backlight 22ᵢ from the internal storage unit of the cumulative quantity calculation part 24A.

Step S46:

The display panel controller 23A determines whether or not the maximum value of cumulated light quantity exceeds the threshold of cumulated light quantity lt.

When the maximum value of cumulated light quantity exceeds the threshold of cumulated light quantity lt, the display panel controller 23A proceeds to step S46. When the maximum value of cumulated light quantity does not exceed the threshold of cumulated light quantity lt, the display panel controller 23A proceeds to step S41.

Step S47:

The display panel controller 23A selects the driving condition for the display panel 21 depending on the maximum value of cumulated light quantity (i.e. the gate-on voltage VGon, the gate-off voltage VGoff, and the common electrode voltage Vcom) with reference to the display panel control table stored on the storage unit 25A. Subsequently, the display panel controller 23A determines the selected driving condition of the display panel 21 as the new driving condition of the display panel 21 afterwards.

Step S48:

Thereafter, the display panel controller 23A drives the display panel 21 based on the selected driving condition.

As described above, the present embodiment sums up light quantities for each sub-backlight 22ᵢ of the backlight 22 with respect to each sub-backlight 22ᵢ so as to produce the cumulated light quantity for each sub-backlight 22ᵢ. Based on the calculated value of cumulated light quantity, the present embodiment estimates the cumulated quantity of light that each sub-backlight 22ᵢ irradiates to its corresponding pixel area of the display panel 21 until the current timing. In addition, the present embodiment selects the maximum value of cumulated light quantity among the estimated values of cumulated light quantity for the sub-backlight 22ᵢ so as to drive the display panel 21 while changing the driving condition depending on the degree of degradation in the pixel area that is estimated to be highly degraded. By driving the display panel 21 based on the driving condition in the highly-degraded pixel area, the present embodiment is able to eliminate differences of transmissivity among pixel areas of the display panel 21, and therefore it is possible to prevent users watching images on screen from visually recognizing irregularities on the display screen.

The present embodiment changes the level of the gate-on voltage VGon for controlling each TFT 211 on the display panel 21 depending on the maximum value of cumulated light quantity. However, it is possible to change the gate-on period instead of the gate-on voltage VGon.

Similar to the second embodiment, another example of the configuration of the display panel control table shown in FIG. 6 is used to describe the gate-on period representing the time of applying the gate-on voltage VGon to the gate of each TFT 211 on the display panel 21 depending on the maximum value of cumulated light quantity. The gate-on period represents the time of turning on the TFT 211.

### Fifth Embodiment

The fifth embodiment is similar to the third embodiment shown in FIG. 11 in terms of its configuration.

The fifth embodiment is designed to select cumulated electric energy with respect to the sub-backlights 22₁ to 22ₙ of the backlight 22 so as to read the driving condition corresponding to the cumulated electric energy from the display panel control table, thus driving the sub-backlights 22ᵢ irradiating light to their corresponding pixel areas on the display panel 21 based on the read driving condition. Each of the sub-backlights 22ᵢ irradiates light to its corresponding pixel area on the display panel 21. For this reason, the present embodiment controls the TFTs 211 of each pixel area corresponding to each sub-backlight 22ᵢ based on the driving condition depending on the cumulated electric energy for each sub-backlight 22ᵢ on the display panel 21. A gate-scanning line is connected to the gates of TFTs 211 so as to apply its gate voltage to the gates of TFTs 211. The gate-scanning line is wired over a plurality of pixel areas. The driving condition for the pixel area corresponding to the sub-backlight 22ᵢ having the highest value of cumulated electric energy is selected from among driving conditions for a pixel area (i.e. a common block) aggregating multiple pixel areas (or pixel blocks) wires with the same gate-scanning line; hence, the selected driving condition is used as the driving condition for all the pixel areas to be driven by the same gate-scanning line.

According to the fifth embodiment as shown in FIG. 11, the display panel controller 23 may select the sub-backlight 22ᵢ whose cumulated electric energy exceeds the cumulated electric energy Pt from among values of cumulated electric energy for the sub-backlight 22₁ to 22ₙ. Subsequently, the display panel controller 23 reads the driving condition for each sub-backlight 22ᵢ whose cumulated electric energy exceeds the cumulated electric energy Pt. The display panel controller 23 selects a gate-scanning line covering the pixel area of the sub-backlight 22ᵢ whose cumulated electric energy exceeds the cumulated electric energy Pt on the display panel 21, and therefore it drives the gate-scanning line based on the driving condition of the sub-backlight 22ᵢ. When controlling the level of the gate-on voltage VGon, the display panel controller 23 should control the gate-off voltage VGoff and the common electrode voltage Vcom in connection with the gate-scanning line as well.

As described above, the present embodiment sums up the amount of electric energy causing light emission with each sub-backlight 22ᵢ of the backlight 22 with respect to each sub-backlight 22ᵢ so as to produce the cumulated electric energy for each sub-backlight 22ᵢ. Based on the calculated value of cumulated electric energy, the present embodiment estimates the cumulated quantity of light that each sub-backlight 22ᵢ irradiates to its corresponding pixel area on the display panel 21 until the current timing. Thus, the present embodiment selects a value of cumulated light quantity exceeding the threshold of cumulated light quantity lt from among the estimated values of cumulated light quantity for the sub-backlights 22ᵢ, and therefore the present embodiment drives the display panel 21 while changing the driving condition for the pixel area that is estimated to be highly degraded based on the selected value of cumulated light quantity. By setting the driving condition for each pixel area on the display panel 21 depending on the degree of degradation, the present embodiment is able to eliminate differences of transmissivity among pixel areas on the display panel 21, and therefore it is possible to prevent users watching images on screen from visually recognizing irregularities on the display screen.

### Sixth Embodiment

The sixth embodiment is similar to the fourth embodiment shown in FIG. 13 in terms of its configuration.

The sixth embodiment is designed to extract cumulated light quantities for the sub-backlights 22ᵢ to 22 of the backlight 22, to read driving conditions depending on cumulated light quantities from the display panel control table, and to thereby drive sub-backlights 22ᵢ irradiating light to the pixel areas on the display panel 21 based on driving conditions. Each sub-backlight 22ᵢ irradiates light to its corresponding pixel area on the display panel 21. Thus, the present embodiment controls the TFTs 211 for the pixel areas corresponding to the sub-backlights 22ᵢ based on driving conditions depending on quantities of light irradiated by the sub-backlights 22ᵢ on the display panel 21. Herein, a gate-scanning line for applying gate voltages to the gates of TFTs 211 is wired over multiple pixel areas corresponding to multiple sub-backlights 22ᵢ. Thus, the driving condition for the pixel area corresponding to the sub-backlight 22ᵢ having the highest value of cumulated light quantity is selected from among driving conditions wired with the same gate-scanning line on the display panel 21, and therefore the selected driving condition is applied to all the pixel areas driven by the same gate-scanning line.

According to the sixth embodiment shown in FIG. 13, the display panel controller 23A may select the sub-backlight 22ᵢ whose cumulated light quantity exceeds the threshold of cumulated light quantity lt among cumulated light quantities of the sub-backlights 22₁ to 22ₙ. The display panel controller 23A reads the diving condition for each sub-backlight 22ᵢ exceeding the cumulated light quantity lt. The display panel controller 23A selects a gate-scanning line covering the pixel area corresponding to the sub-backlight 22ᵢ exceeding the cumulated light quantity lt so as to drive the gate-scanning line based on the driving condition for the sub-backlight 22ᵢ.

When controlling the level of the gate-on voltage VGon, the display panel controller 23A controls the gate-off voltage VGoff and the common electrode voltage Vcom in connection with the gate-scanning line as well.

As described above, the present embodiment sums up the quantity of light emitted by each sub-backlight 22ᵢ of the backlight 22 with respect to each sub-backlight 22ᵢ so as to produce the cumulated light quantity for each sub-backlight 22ᵢ, thus estimating the cumulated quantity of light that each sub-backlight 22ᵢ irradiates to each pixel area on the display panel 21 until the current timing. The present embodiment selects the cumulated light quantity exceeding the threshold of cumulated light quantity lt from among the estimated values of cumulated light quantity for the sub-backlight 22ᵢ, and therefore the present embodiment drives the display panel 21 while changing the driving condition for the pixel area that is estimated to be highly degraded based on the selected value of cumulated light quantity. By setting the driving condition for each pixel area on the display panel 21 depending on the degree of degradation, the present embodiment is able to eliminate differences of transmissivity among pixel areas on the display panel 21, and therefore it is possible to prevent users watching images on screen from visually recognizing irregularities on the display screen.

The foregoing configurations according to the first to sixth embodiments can be similarly applied to any materials of TFTs such as amorphous silicon, polysilicon, oxide semiconductor, and organic semiconductor.

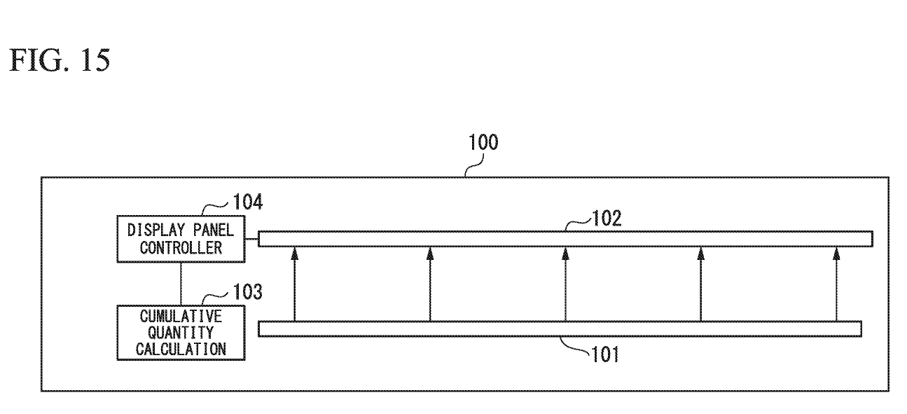

FIG. 15 is a diagram used to explain the concept of the present invention. In FIG. 15, an image display device 100 of the present invention includes a backlight 101, a transmission-type display panel 102 disposed on the front face of the backlight 101, a cumulative quantity calculation part 103 for calculating the cumulated light quantity of the backlight 101, and the display panel controller 104 for changing the driving condition of the display panel 102.

The cumulative quantity calculation part 103 calculates the cumulated quantity of light that the backlight 101 irradiates to the display panel 102.

The display panel controller 104 controls the transmissivity for pixels of the display panel 102 displaying image data based on the driving condition (i.e. the driving condition for TFTs configured to control the transmissivity of the display panel 102) depending on the cumulated light quantity calculated by the cumulative quantity calculation part 103. Thus, it is possible to drive TFTs for controlling the transmissivity for pixels of the display panel 102, which may be degraded due to irradiation of light by the backlight 101, depending on the degree of degradation in TFTs, which can be estimated based on the cumulated light quantity, and therefore it is possible to display images without irregularities.

In this connection, it is possible to provide an external computer system realizing the control function of an image display device with respect to the process of changing the driving condition for a display panel depending on the degree of degradation in TFTs on the display panel of an image display device as shown in FIGS. 1, 7, 11, and 13. Herein, the “computer system” may embrace OS and hardware such as peripheral devices.

Heretofore, the foregoing embodiments of the present invention are described in detail with reference to the drawings, however, detailed configurations are not necessarily limited to those embodiments; hence, it is possible to embrace any design choices not departing from the subject matter of the invention.

### INDUSTRIAL APPLICABILITY

In an image display system, liquid-crystal display panels and other display panels configured to display images by adjusting light quantities of pixels with TFTs can be applied to an image display device using MEMS (Micro Electro-Mechanical System) for adjusting light quantity with shutters.

### REFERENCE SIGNS LIST

1, 1A, 2, 2A . . . image display device
11, 21 . . . display panel
12, 22, 22A . . . backlight
13, 13A, 23, 23A . . . display panel controller
14, 14A, 24, 24A . . . cumulative quantity calculation part
15, 15A, 25, 25A . . . storage unit
16, 26 . . . electric energy detector
17, 27 emission controller
18, 28 . . . light quantity detector
19, 19₁, 19₂, 19₃, 19ₙ₋₁, 19ₙ . . . optical sensor
22₁, 22₂, 22₃, 22ₙ₋₁, 22ₙ . . . sub-backlight
111, 211 . . . TFT
200 . . . light

1. An image display device comprising:
a backlight;
a display panel of a transmission type disposed on a front face of the backlight;
a cumulative quantity calculation part configured to calculate a cumulative quantity representing either cumulated electric energy cumulating power supplied to the backlight or a cumulated light quantity of the backlight; and
a display panel controller configured to change a driving condition for the display panel depending on the cumulative quantity.

2. The image display device according to claim 1, wherein the display panel includes a plurality of pixel blocks,
wherein the pixel block is a pixel area including a predetermined number of pixels,
wherein the backlight is divided into a plurality of light-source blocks in connection with the plurality of pixel blocks,
wherein the cumulative quantity calculation part calculates the cumulative quantity for each light-source block as a block-cumulated quantity, and
wherein the display panel controller changes the driving condition for the plurality of pixel blocks based on as maximum value among block-cumulated quantities for the light-source blocks.

3. The image display device according to claim 1, wherein the display panel includes a plurality of pixel blocks,
wherein the pixel block is a pixel area including a predetermined number of pixels,
wherein the plurality of pixel blocks form a plurality of common blocks,
wherein the common block is a pixel area including the plurality of pixel blocks commonly wired with a predetermined scanning line,
wherein the backlight is divided into a plurality of light-source blocks in connection with the plurality of pixel blocks,
wherein the cumulative quantity calculation part calculates the cumulated electric energy or the cumulated light quantity for the plurality of light-source blocks as block-cumulated quantity, and
wherein the display panel controller changes the driving condition for the common block including the pixel block corresponding to the light-source block having a maximum value of the block-cumulated quantity among block-cumulated quantities of the light-source blocks.

4. The image display device according to claim 1, wherein the driving condition comprises a gate-driving condition for a field-effect transistor used to control transmissivity for each pixel on the display panel.

5. The image display device according to claim 4, wherein the gate-driving condition refers to one of or both of a control for a gate voltage or a control for a period of applying the gate voltage.

6. The image display device according to claim 1, further comprising a driving condition table that writes or stores a correlation between the cumulated electric energy and the driving condition for the cumulated electric energy or a correlation between the cumulated light quantity and the driving condition for the cumulated light quantity in advance,
wherein the display panel controller reads the driving condition depending on the cumulated electric energy or the cumulated light quantity from the driving condition table so as to drive the display panel based on the driving condition.

7. The image display device according to claim 5, wherein the display panel controller increases a voltage for driving the field-effect transistor or a period for applying the voltage to the field-effect transistor as the cumulated electric energy or the cumulated light quantity increases.

8. The image display device according to claim 1, wherein the cumulative quantity calculation part calculates the cumulated light quantity as a cumulative value of measured values measured by an optical sensor attached to the display panel.

9. The image display device according to claim 1, wherein the cumulative quantity calculation part calculates the cumulated light quantity by cumulating intensities of light emitted by the backlight measured with an optical sensor attached to the display panel.

10. An image display method adapted to an image display device including a backlight and a display panel of a transmission type disposed on a front face of the backlight, the image display method comprising:
calculating a cumulative quantity representing either cumulated electric energy cumulating power supplied to the backlight or cumulated light quantity of the backlight; and
changing a driving condition for the display panel based on the cumulative quantity.
